(19) United States
(12) Patent Application Publication
(10) Pub. No.: US 2013/0282500 A1
(43) Pub. Date: Oct. 24, 2013

(54) VEHICLE FUELING SYSTEM AND METHOD

(71) Applicant: Murillo Grandino Latorre, Sao Paulo (BR)

(72) Inventor: Murillo Grandino Latorre, Sao Paulo (BR)

(21) Appl. No.: 13/453,173

(22) Filed: Apr. 23, 2012

(51) Int. Cl. G06Q 20/22; G06Q 20/20; G08B 5/22

(52) U.S. Cl. 705/17; 340/6.1; 705/16; 705/39

(57) ABSTRACT

A vehicle fuelling system and method which uses an internet-based user interface accessible by a user. The user accesses the user interface through a smartphone application, a computing device, call center, or a kiosk situated at a parking facility. The user accesses the user interface to notify a service provider that a vehicle in need of fuel. While the vehicle is parked in a parking lot, the service provider responds to the user's notification, and dispatches a fuel truck to deliver fuel to the vehicle. This allows a user to have an unattended vehicle fuelled. The user is automatically charged for the fuel and service, and a notification and invoice is provided to the user.

### FIELD OF THE INVENTION

The present invention relates to the field of vehicle fueling systems and methods and, more particularly, to a system for automated scheduling of the fueling of vehicles with minimal user interaction and related methods.

### BACKGROUND OF THE INVENTION

Refueling automobiles is a necessary task for drivers of automobiles. This task takes time from a driver's day and adds additional driver responsibility, for a driver must be ever vigilant to prevent the automobile from running out of gas.

In the case of unexpected trips, emergencies, or merely being rushed for time, a stop at a gas station to remedy a soon-to-be empty gas tank can be extremely inconvenient. Running out of gas on a highway or during the winter can be a dangerous event, and is a potentially harsh consequence for neglecting to stop for a gas refill.

Most drivers spend at least some time with their automobiles parked in employers' parking lots, malls, shopping centers, or grocery stores. During these times, the automobiles generally remain untouched. This is time when a vehicle could be potentially refueled, but this opportunity is normally squandered, for there is no means for refueling a vehicle in the driver's absence.

Accordingly, there is a need to employ an automated system for the refueling of automobiles in a driver's absence to save time and prevent driver stress. There is a further need schedule or notify a gas provider that an automobile is in need of refueling. There is also a need to automate payment to the gas provider.

These and other objects of the present invention are attained by a system of arranging fuel delivery to parked automobiles. The system comprises a fuel delivery vehicle capable of approaching an automobile for the purpose of filling the automobile's gas tank. A driver registers their vehicle through one of a web page, a kiosk, and smartphone application, which are each information conduits through which payment for fuel is arranged and notification that an automobile is present and in need of refueling is provided to the fuel provider.

### SUMMARY OF THE INVENTION

This and other objects, features, and advantages in accordance with the present invention are provided by a system for fuelling vehicles, comprising an internet-based user interface for a user to interact with the system. The user interface comprises a dialogue to prompt a user to notify a service provider that a user's vehicle is in need of fuel. Another dialogue prompts a user to notify a service provider of a location to find the user's vehicle. A fuel truck associated with the service provider is dispatched, upon notification by the service provider, to find the user's vehicle and fill the user's vehicle with fuel. After a fuel truck operator fills the user's vehicle with fuel from the fuel truck, a notification is sent to the user indicating that the fuelling of the user's vehicle is complete.

The user interface is one or more of a smartphone application, a computer interface, an internet website, and a kiosk. The kiosk comprises a point of sale interface and a credit card reader. The user interface comprises a dialogue to prompt the user to enter a user's credentials to access a personal user account. The information of the personal user account is stored in a database.

The personal user account comprises the user's personal data, wherein the user's personal data comprises at least one of a user's name, user's address, and a user's phone number. The personal user account also comprises the user's account data, wherein the user's account data comprises a username, a password, and vehicle service preferences. The personal user account also comprises the user's payment data, wherein the user's payment data comprises at least one of a billing address, credit card number, bank account number, and online payment processor credentials. The personal user account also comprises the user's vehicle information, wherein the user's vehicle information comprises at least one of the vehicle's manufacturer, the vehicle's model, the vehicle's color, the vehicle's year of manufacture, the vehicle's license plate number, and the vehicle's fuel requirements.

The fuel truck comprises at least one tank to store fuel and a dispenser nozzle to engage the user's vehicle's fuel system for the purpose of dispensing fuel into the user's vehicle's fuel tank. A metering device in communication with the dispenser nozzle measures the volume of fuel pumped into the user's vehicle. A computing device stores the identification of the user's vehicle, the volume of fuel dispensed into the user's vehicle, the type of fuel pumped into the user's vehicle, and the price of the fuel pumped into the user's vehicle.

This information is summarized in a notification, and the notification is wirelessly transmitted to the user. In particular, the notification comprises: the volume of fuel dispensed into the user's vehicle, the type of fuel pumped into the user's vehicle, the price of the fuel pumped into the user's vehicle, the date and time the fuel was delivered to the user's vehicle, and the total amount of money charged to the user.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a flow chart illustrating a preferred embodiment of the invention; and

FIG. 2 is a flow chart illustrating steps for creating a user account.

### DETAILED DESCRIPTION OF THE PREFERRED EMBODIMENTS

In the Summary of the Invention above and in the Detailed Description of the Invention and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

The term “comprises” is used herein to mean that other components, steps, etc. are optionally present. When reference is made herein to a method comprising two or more defined steps, the steps can be carried in any order or simultaneously (except where the context excludes that possibility), and the method can include one or more steps which are carried out before any of the defined steps, between two of the defined steps, or after all of the defined steps (except where the context excludes that possibility).

In this section, the present invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

The User Interface

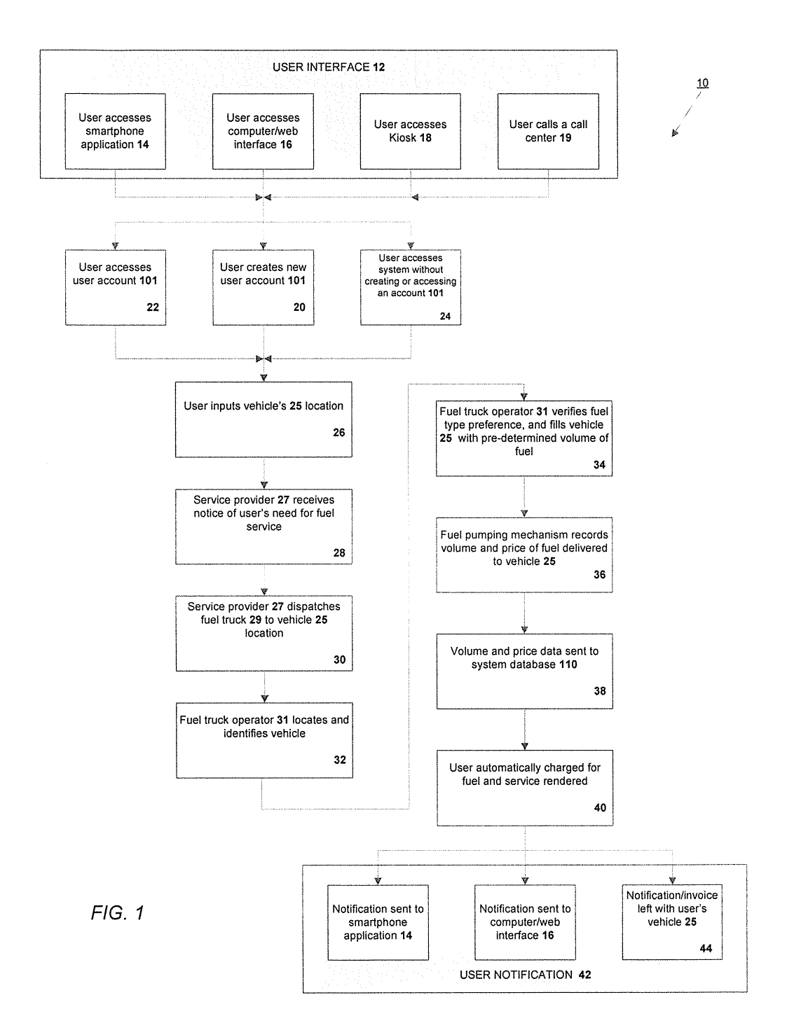

FIG. 1 is a flow chart that graphically illustrates the vehicle fueling system 10. The vehicle fueling system 10 comprises a user interface 12. The user interface 12 is a software application with at least one of a text-based user interface, graphical user interface, and a combination thereof, and is the primary means through which a user is able to interact with the system 10. The user interface 12 is accessible by the user through a smartphone application 14 (e.g. Android™, Blackberry™, iPhone™). A computer based system 16 (e.g. desktop pc, laptop pc, tablet computing device, PDA) that accesses the internet is also utilized by the user to access the system 10. The computer-based system 16 comprises an internet-based user interface 12. In another embodiment, a hardware kiosk 18 is accessed by the user, and the kiosk is the means for the user to access the user interface 12. An alternative to a software/hardware based interface is a call center 19, wherein a customer can make a telephone call to arrange fueling services.

All embodiments of the user interface 12 allow the user to create 20 a new user account 101. It should be noted that the user has the option to access the user interface 12 through the choice of access points 12, 14, 16, and is not restricted to any particular type of access point 12, 14, 16, since users account information is accessible from any access point 12, 14, 16 or call center 19.

The User Account

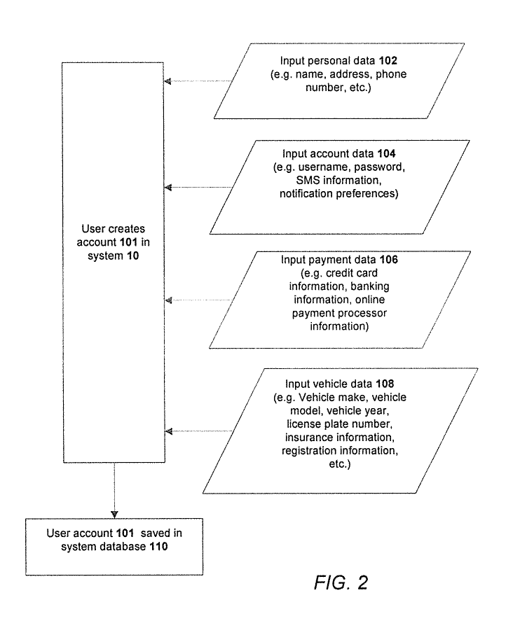

FIG. 2 is a flow chart illustrating how a new user account 101 is created. A user account 101 is a compilation of information that includes personal data 102, account data 104, payment data 106, and vehicle data 108. A user account 101 is not necessary for the system 10 to function, but will augment the user's experience and expedite service, since information saved in a user account need not be re-entered at the time the user engages the system 10.

Personal data 102 includes name, address, phone numbers, email addresses, SMS contact information, geo-location data, voice over internet protocol (VoIP) information, or any other data used to describe or identify an individual user.

Account data 104 includes username, password, interface preferences, notification preferences, and any other information used for an internet-based user account.

Payment data 106 includes credit card information or online payment system information or direct access to financial institutions such as Paypal™ or Google™ checkout, credit card accounts, bank accounts, credit card processors, electronic banking, or any other financial information or access.

Vehicle data 108 includes vehicle 25 make, manufacture, year of assembly, vehicle 25 color, license plate number, insurance data, registration data, grade of fuel required, service preferences, and any other vehicle 25 data.

The system 10 saves user account information 102, 104, 106, 108 in a file or database 110. In one embodiment, the database 110 resides on the hardware (i.e. smartphone, computer, kiosk, etc.). The file or database 110 resides at an external location that is electronically accessible by the system 10.

Turning again to FIG. 1, when a user has already created a user account 101, the user simply logs on to the system 10 to access 22 their user account 101. In the event that a user does not wish to create an account 101, the user may enter information necessary to identify the vehicle 25, the vehicle location, and payment information into the user interface 12 and schedule service in the absence of a user account 101.

The Kiosk

Access to the user interface 12 using a kiosk 18 is one embodiment where a lack of a user account 101 is contemplated. The kiosk 18 is situated at a large urban/suburban center such as a mall, chain retailer, office complex, or airport, wherein a user parks their car and accesses the kiosk 18 to engage the system 10. The kiosk 18 comprises a screen to display the user interface 12 to the user and an input device so that the user can input data through the user interface 12. The input device is at least on of a remote control, computer mouse, keyboard, infrared input device, radio frequency input device, Bluetooth™ input device, RFID device, touch-sensitive screen input, or any other form of device input. The kiosk also comprises a magnetic credit card reader for the purpose of providing a credit card to the system 10 for payment. In one embodiment, the kiosk 18 comprises a mechanism for accepting cash currency. In yet an additional embodiment, the kiosk 18 can provide change to a customer that has paid in cash, yet ordered a lesser value of fuel than the value of cash provided.

Scheduling Fuel Service

The user in need of fuel service engages the user interface 101 to schedule a fuel delivery. To schedule a fuel delivery, the user must input 26 their vehicle's 25 location or convey this information to a call center 19. In one embodiment, the vehicle's 25 location is described by relaying an assigned designation of a particular parking spot (e.g. a numbered parking spot). In one embodiment, the fuel delivery is relegated to a finite parking lot space, so merely alerting the system 10 of a vehicle's 25 presence in that parking lot is sufficient notification for the vehicle to be found. In this embodiment, the vehicle 25 would be identified by at least one of make, model, year, color, license plate number, and adhesive sticker indicating participation in the system 10.

In the case where the user has no account 101, the user must input the grade of fuel desired, the amount of fuel desired, and a method of payment. For a smartphone application 14, a computer interface 16, or call center 19 the user enters credit card information or other financial information necessary to effectuate a payment. In the case of a kiosk 18, the user has the option to swipe a credit card through a magnetic credit card reader to effectuate a payment.

Fuel Delivery

Still referring to FIG. 1, when a user accesses the user interface 12 to request fuel delivery, a service provider receives notice of the user's need for fuel. A service provider 27 is at least one of a company with a fleet of fuel trucks 29, a company that subcontracts with fuel truck 29 providers, and an individual fuel truck 29 operator. Upon notification of a user's need for fuel service, the service provider 27 dispatches 30 a fuel truck 29 to a user's location.

The operator 31 of the fuel truck 29, after being dispatched, locates 32 the vehicle 25 in need of fuel service. The vehicle 25 identification is verified by at least one of make, model, year, color, license plate number, and adhesive sticker indicating participation in the system 10. The operator 31 of the fuel truck 29 reviews and verifies 34 the fuel order to accurately dispense the appropriate grade and volume of fuel as ordered by the user of the system 10. If the user has an account 101, the vehicle 25 identity, type and grade of required fuel, and volume requirements are stored in the system's 10 database 110 and transmitted to the service provider 27 automatically. If the user has no account 101, this information must be entered into the user interface 12 each time fuel service is requested.

The operator 31 of the fuel truck 29, after verifying the vehicle 25 identity, situates the fuel truck 29 in close proximity to the user's vehicle 25. The operator 31 then fills the vehicle 25 with a pre-determined volume of fuel 34.

The fuel truck 29 comprises at least one storage tank capable of holding vehicle fuel such as gasoline and diesel fuel. In one embodiment, the fuel truck 29 comprises a plurality of storage tanks so that different fuels and different octane grades of fuel are available for dispensing. At least one petroleum filling nozzle communicates with at least one storage tank so that fuel is capable of being delivered to a vehicle 25. The user must make the gas cap of the vehicle 25 accessible, typically by leaving the fuel cap door unlocked or open in the case of a vehicle 25 with a locking fuel cap door.

The petroleum filling nozzle communicates with a flow meter to record the volume of fuel dispensed 36 into a user's vehicle 25. The volume of fuel dispensed and the price of the fuel dispensed are electronically transmitted 38 to the system's database 110. In one embodiment, the flow meter is electronic, and the volume and grade of fuel is automatically transmitted to the database 110. In another embodiment, the operator 31 must manually enter into a computer-based interface the volume and price of the fuel dispensed, and this populates the database 110 with the fuel volume data and price data. The user is then automatically charged for the fuel and service rendered by the service provider 27.

User Service Notification

Still referring to FIG. 1, the user is notified 42 when fuel service is rendered. The notification includes at least one of date of service, time of service, volume of fuel, grade of fuel, cost of fuel, cost of service, payment verification, and any other relevant invoice data. The user is notified 42 by at least one of email, SMS message, phone call, notification on smartphone application 14, notification on internet interface 16, paper invoice, and any other manner of service notification known in the art. The paper invoice is attached 44 to the user's vehicle 25. In on embodiment, the paper invoice is mailed to a user's designated street address.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

Method of Fuelling a Vehicle

The invention contemplates a method of fuelling a vehicle. In an illustrative embodiment of the method, a digital user interface is provided to a customer. The user interface is accessed through at least one of a smartphone application, a computer interface, an internet website, a telephone call center, and a kiosk. The user interface is used so that a customer provides, and the system receives, personally identifying information from a customer that for purposes of privacy, linking an account with a particular vehicle, and in one embodiment also linking an account with a method of payment. The user interface is also used so that a customer provides, and the system receives, information that identifies a customer's vehicle, such as a license plate number and VIN number. The user interface is also used so that a customer provides, and the system receives, payment information such as bank account information, check routing information, and credit/debit card numbers and related information necessary to process a payment. In one embodiment of this method, information that identifies a customer is saved in a database. Information that identifies a customer's vehicle is saved in a database. Information necessary for a customer to effectuate an electronic payment is saved in a database.

A customer places an order through the user interface, and the system receives the order to fill the customer's vehicle with fuel. A fuel truck capable of dispensing fuel is dispatched to locate the customer's vehicle, positively identify the customer's vehicle, and fill the vehicle with fuel upon receiving an order. In one embodiment, a recurring order is placed by the customer so that each time the fuel delivery vehicle identifies the customer's vehicle, the fuel tank is “topped off.”

The fuel truck dispenses and meters the fuel dispensed into the customer's vehicle. A price for the fuel is calculated, and the customer is charged the price for the volume of fuel dispensed into the customer's vehicle. In one embodiment, an electronic financial source of the customer is automatically charged by the system. In another embodiment, the customer swipes a credit or debit card in a kiosk to authorize a credit card charge, and the system charges that credit card. In yet another embodiment, the system receives paper currency from a customer, the customer inserting paper currency into a kiosk capable of accepting paper currency.

1. A system for fuelling vehicles, comprising:
a computer based system comprising an internet-based user interface for a user to interact with a service provider system;
a means for the computer based system to notify a service provider that a user's vehicle is in need of fuel;
a means for the computer based system to notify a service provider of a location to find the user's vehicle;
a means for displacing a fuel truck associated with the service provider, upon notification by the service provider, to find the user's vehicle and fuel the user's vehicle; and
a means for sending a notification to the user indicating that the fuelling of the user's vehicle is complete.

2. The invention of claim 1, wherein the internet-based user interface is accessed through at least one of a smartphone, desktop pc, laptop pc, tablet computing device, PDA, a voice over internet protocol (VoIP) call center, and a kiosk.

3. The invention of claim 1, wherein the fuel truck comprises:
a metering device in communication with a dispenser nozzle for measuring a volume of fuel pumped into the user's vehicle;
a computing device that stores the identification of the user's vehicle, the volume of fuel dispensed into the user's vehicle, a type of fuel pumped into the user's vehicle, and a price of the fuel pumped into the user's vehicle.

4. The invention of claim 2, wherein the kiosk comprises a point of sale interface.

5. The invention of claim 4, wherein the kiosk comprises a credit card reader.

6. The invention of claim 4, wherein the kiosk comprises a means to accept paper currency.

7. The invention of claim 2, wherein the user interface comprises a dialogue to prompt the user to enter a user's credentials to access a personal user account.

8. The invention of claim 3, wherein the notification is transmitted to the user.

9. The invention of claim 7, wherein information of the personal user account is stored in a database.

10. The invention of claim 8, wherein the notification comprises:
the volume of fuel dispensed into the user's vehicle;
the type of fuel pumped into the user's vehicle;
the price of the fuel pumped into the user's vehicle;
a date and time the fuel was delivered to the user's vehicle; and
a total amount of money charged to the user.

11. The invention of claim 9, wherein the personal user account comprises:
the user's personal data, wherein the user's personal data comprises at least one of a user's name, user's address, and a user's phone number;
the user's account data, wherein the user's account data comprises a username, a password, and vehicle service preferences;
the user's payment data, wherein the user's payment data comprises at least one of a billing address, credit card number, bank account number, and online payment processor credentials;
the user's vehicle information, wherein the user's vehicle information comprises at least one of the vehicle's manufacturer, the vehicle's model, the vehicle's color, the vehicle's year of manufacture, the vehicle's license plate number, and the vehicle's fuel requirements.

12. A method of fuelling a vehicle, the method comprising utilizing the system for fuelling a vehicle of claim 1.

13. A method of fuelling a vehicle in a customer's absence comprising the steps of:
providing a computer based system comprising a digital user interface to a user for the purpose of scheduling via the internet a fuel delivery by a fuel truck in communication with a service provider system, wherein the computer based system comprises a smartphone, desktop pc, laptop pc, tablet computing device, or PDA; and
the service provider system—
receiving information that personally identifies a customer;
receiving information that identifies a customer's vehicle;
receiving payment information from a customer;
receiving an order for fuel from a customer;
an operator of the fuel truck—
locating a customer's vehicle;
fuelling a customer's vehicle by use of a truck capable of dispensing and metering fuel;
metering a volume of fuel dispensed into a customer's vehicle;
calculating a price of the volume of fuel dispensed into a customer's vehicle; and
electronically charging to the customer the price of the volume of fuel dispensed into a customer's vehicle.

14. The method of claim 13, further comprising the steps of the service provider system:
saving information that identifies a customer in a database;
saving information that identifies a customer's vehicle in a database; and
saving a customer's payment information in a database.

15. The method of claim 13, further comprising the step of receiving paper currency from a customer.

16. The method of claim 13, further comprising the step of reading a customer's credit card for the purpose of charging a fuel purchase to the credit card.

17. The method of claim 13, wherein the user interface is accessed through at least one of a smartphone application, a computer interface, an internet website, a voice over internet protocol (VoIP) call center, and a kiosk.

18. A method of fuelling a vehicle in a customer's absence comprising the steps of:
providing a computer based system comprising a user interface for a customer to communicate with a vehicle fuelling system via the internet;
the vehicle fueling system—
receiving a customer's vehicle location;
receiving a customer's fuel type preference;
receiving notice of a customer's need for fuel service;
dispatching a fuel delivery vehicle to the customer's vehicle;
locating the customer's vehicle;
positively identifying the customer's vehicle;
fuelling a customer's vehicle with the customer's preferred fuel type;
recording volume and price of fuel delivered to customer's vehicle;
sending via the internet fuel price data to a database;
calculating price of fuel and fuel service;
charging the customer via the internet for fuel and fuel services rendered; and
wirelessly notifying the customer that fuelling service is complete.

19. The method of claim 18, wherein the computer based system is one or more of a smartphone, desktop pc, laptop pc, tablet computing device, PDA, and kiosk.

20. The method of claim 18, wherein the wireless notification comprises: the volume, type, and price of fuel dispensed into the customer's vehicle, and the date and time the fuel was delivered.
